(19) United States
(12) Patent Application Publication
(10) Pub. No.: US 2022/0202527 A1
(43) Pub. Date: Jun. 30, 2022

(54) ROOT CANAL DENTAL INSTRUMENT

(71) Applicant: William L. Wildey, (US)

(72) Inventors: William L. Wildey, Hurst, TX (US); Steven S. Senia, San Antonio, TX (US)

(21) Appl. No.: 17/697,550

(22) Filed: Mar. 17, 2022

Related U.S. Application Data
(62) Division of application No. 16/424,009, filed on May 28, 2019.
Application No. 16/424,009 is a continuation-in-part of application No. 15/792,986, filed on Oct. 25, 2017, now abandoned.

(51) Int. Cl. A61C 5/42; A61C 5/50; A61C 5/44

(52) U.S. Cl. CPC A61C 5/42; A61C 5/44; A61C 5/50

(57) ABSTRACT

A root canal dental instrument is disclosed. The dental instrument includes a handle configured to be coupled to a dental hand piece, and a spiral spindle coupled to the handle. The spiral spindle includes a shaft, which includes a rounded tip, and a continuous spiral protrusion abutting the shaft and extending along a length of the shaft, the continuous spiral protrusion ending on the shaft prior to the rounded tip.

### RELATED APPLICATIONS

This application is a divisional of co-pending U.S. patent application Ser. No. 16/424,009, filed on May 28, 2019, entitled “ROOT CANAL DENTAL INSTRUMENT,” which is continuation-in-part of U.S. patent application Ser. No. 15/792,986, filed on Oct. 25, 2017, entitled “ROOT CANAL FILLING INSTRUMENT,” each of which is hereby incorporated herein by reference in its entirety.

### TECHNICAL FIELD

The embodiments relate to a dental instrument, and in particular to a root canal dental instrument for irrigating and/or obturating a root canal during a root canal treatment.

### BACKGROUND

A root canal of a tooth often includes a number of lateral canals that are connected to a primary canal. When a dentist performs a root canal procedure, it is desirable to urge irrigant liquid into the entire root canal space, including lateral canals, for better cleansing. It is also desirable to seal the lateral canals with a sealer material to prevent bacterial growth, and for other reasons.

### SUMMARY

The embodiments relate to a flexible root canal dental instrument for irrigating and/or obturating a root canal during a root canal treatment. Conventionally, dentists use dental instruments and techniques that remove a substantial amount of dentin from the root canal walls. Unfortunately, this weakens the tooth, and tooth fractures after root canal treatments have become commonplace. Accordingly, more recently, new techniques have been developed that attempt to minimize the amount of dentin removed from the root canal walls during a root canal treatment. These techniques are sometimes referred to as being “minimally invasive.” While the benefit of a minimally invasive technique retains much of the tooth's structural integrity, the minimally invasive techniques make it much more difficult for a dentist to irrigate and obturate (i.e., fill) a root canal because the space in which the dentist can work is greatly reduced. Conventional root canal instruments are not designed to obturate and irrigate minimally prepared root canals, and thus they cannot be used for minimally invasive techniques. Conventional spiral root canal instruments do not work in small canals because the spiral would have to be made so small that it would essentially become a nearly straight piece of wire which would not be effective in moving sealer within the root canal system. Even in conventional, non-minimally invasive root canal treatments, conventional spiral root canal instruments frequently break apart or unravel when the spiral root canal instrument meets resistance in the canal. If the spiral root canal instrument breaks in the root canal, a surgical procedure may be necessary to remove the broken fragment(s). While a conventional spiral root canal instrument could be made smaller, conventional materials used in such spiral root canal instruments would be even more likely to break.

In one embodiment a dental instrument is provided. The dental instrument includes a handle configured to be coupled to a dental hand piece and a spiral spindle coupled to the handle. The spiral spindle comprises a shaft comprising a rounded tip, and a continuous spiral protrusion abutting the shaft and extending along a length of the shaft, the continuous spiral protrusion ending on the shaft prior to the rounded tip.

In another embodiment a method of manufacturing a dental instrument is provided. The method includes accessing, by a computing device comprising a processor device, a data file that defines a dental instrument, the dental instrument comprising a handle configured to be coupled to a dental hand piece and a spiral spindle coupled to the handle. The spiral spindle comprises a polymeric shaft comprising a tapered shaft portion and a rounded tip and a polymeric continuous spiral protrusion abutting the polymeric shaft and extending along a length of the polymeric shaft, the polymeric continuous spiral protrusion ending on the polymeric shaft prior to the rounded tip. The method further includes sending, by the computing device to a three-dimensional (3D) printer, the data file to cause the 3D printer to print the dental instrument.

In another embodiment a method of manufacturing a dental instrument according to another embodiment is provided. The method includes providing a mold having an interior volume that defines a dental instrument comprising a handle configured to be coupled to a dental hand piece and a spiral spindle coupled to the handle. The spiral spindle comprises a polymeric shaft comprising a tapered shaft portion and a rounded tip, and a polymeric continuous spiral protrusion abutting the polymeric shaft and extending along a length of the polymeric shaft, the polymeric continuous spiral protrusion ending on the polymeric shaft prior to the rounded tip. The method further includes injecting, into the mold, a polymeric material that is in a flowable state. The method further includes allowing the polymeric material to cool to a solid state and removing, from the mold, the dental instrument.

Those skilled in the art will appreciate the scope of the disclosure and realize additional aspects thereof after reading the following detailed description of the embodiments in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 illustrates a perspective view of a root canal filling instrument according to one embodiment;

FIG. 2 illustrates a perspective view of a root canal filling instrument, according to another embodiment;

FIG. 3 illustrates a perspective view of a root canal filling instrument, according to yet another embodiment;

FIG. 4 illustrates a root canal filling instrument in conjunction with a dental hand piece;

FIG. 5 illustrates the root canal filling instrument immediately prior to insertion into a tooth, according to one embodiment;

FIG. 6 illustrates the root canal filling instrument urging material into lateral canals of a root canal of a tooth, according to one embodiment;

FIG. 7 is a flowchart of a method for filling a root canal of a tooth with a material, according to one embodiment;

FIG. 8 illustrates a perspective view of a dental instrument according to another embodiment;

FIG. 9 is a cross-section of a spiral spindle illustrated in FIG. 8 along section 9-9 of FIG. 8;

FIG. 10 illustrates another perspective view of the dental instrument illustrated in FIG. 8;

FIG. 11 illustrates a perspective view of a dental instrument according to another embodiment;

FIG. 12 illustrates a perspective view of a dental instrument according to another embodiment;

FIG. 13 is a cross-section of a spiral spindle along section 13-13 of FIG. 12;

FIG. 14 illustrates another perspective view of the dental instrument illustrated in FIG. 12;

FIG. 15 is a block diagram of a system suitable for manufacturing a dental instrument according to one embodiment;

FIG. 16 is a flowchart of a method for manufacturing a dental instrument according to one embodiment; and

FIG. 17 is a flowchart of a method for manufacturing a dental instrument according to another embodiment.

### DETAILED DESCRIPTION

The embodiments set forth below represent the information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the embodiments are not limited to any particular sequence of steps. The term “about” used herein in conjunction with a numeric value means any value that is within a range of ten percent greater than or ten percent less than the numeric value.

As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B.

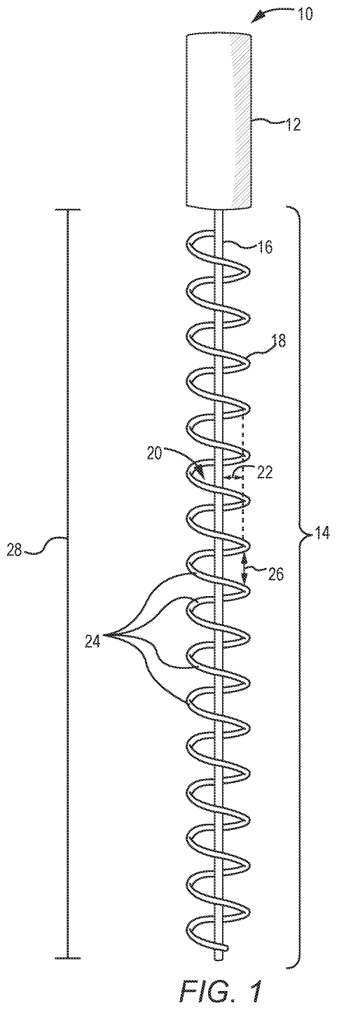

FIG. 1 illustrates a perspective view of a root canal filling instrument 10 according to one embodiment. The root canal filling instrument 10 includes a shaft 12 that is configured to be coupled to a dental hand piece (not illustrated). The root canal filling instrument 10 also includes a material spreader 14. The material spreader 14 includes a spindle 16 coupled to and extending from the shaft 12. The material spreader 14 also includes a spiral wire 18 coupled to the spindle 16. The spiral wire 18 defines a columnar void 20. The spindle 16 extends into the columnar void 20. In some embodiments, the spindle 16 extends an entire length of the columnar void 20, and extends beyond a length of the spiral wire 18.

In some embodiments, a distance 22 in a range between about 0.0 mm to about 5 mm may separate an exterior surface of the spindle 16 from an interior surface of the spiral wire 18 in a direction perpendicular to the length of the spindle 16. The spindle 16 may have a diameter in a range between about 0.01 mm to about 5 mm. The spiral wire 18 may have a diameter in a range between about 0.1 mm to about 5 mm. The spiral wire 18 comprises a plurality of loops 24, and a distance 26 between the loops 24 may be in a range between about 0.0 mm to about 25 mm.

In some embodiments, the material spreader 14 may comprise stainless steel, nickel titanium, titanium, carbon steel, plastics, carbon fiber, or composites. The material spreader 14 may have a length 28 in a range between about 1 mm to about 50 mm.

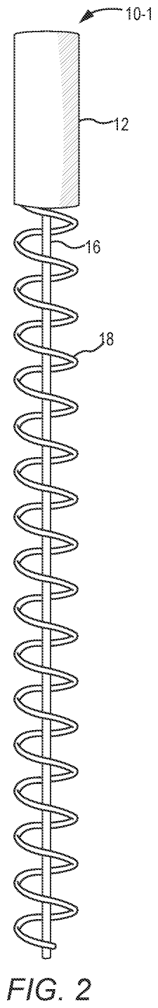

FIG. 2 illustrates a perspective view of a root canal filling instrument 10-1 according to another embodiment. The root canal filling instrument 10-1 is substantially similar to the root canal filling instrument 10 illustrated in FIG. 1, except the spiral wire 18 is coupled to the shaft 12 rather than the spindle 16.

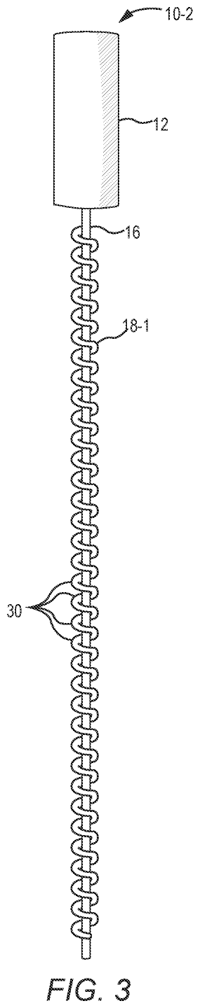

FIG. 3 illustrates a perspective view of a root canal filling instrument 10-2 according to yet another embodiment. In this embodiment, a spiral wire 18-1 defines a narrower columnar void than those illustrated in FIGS. 1 and 2, and thus the distance between the exterior surface of the spindle 16 and an interior surface of the spiral wire 18-1 is less than the distance 22 (FIG. 1) between the exterior surface of the spindle 16 and the interior surface of the spiral wire 18 illustrated in FIG. 1. The spiral wire 18-1 is also more tightly wound than the spiral wire 18, and thus loops 30 of the spiral wire 18-1 are closer to one another than the loops 24 (FIG. 1) of the spiral wire 18.

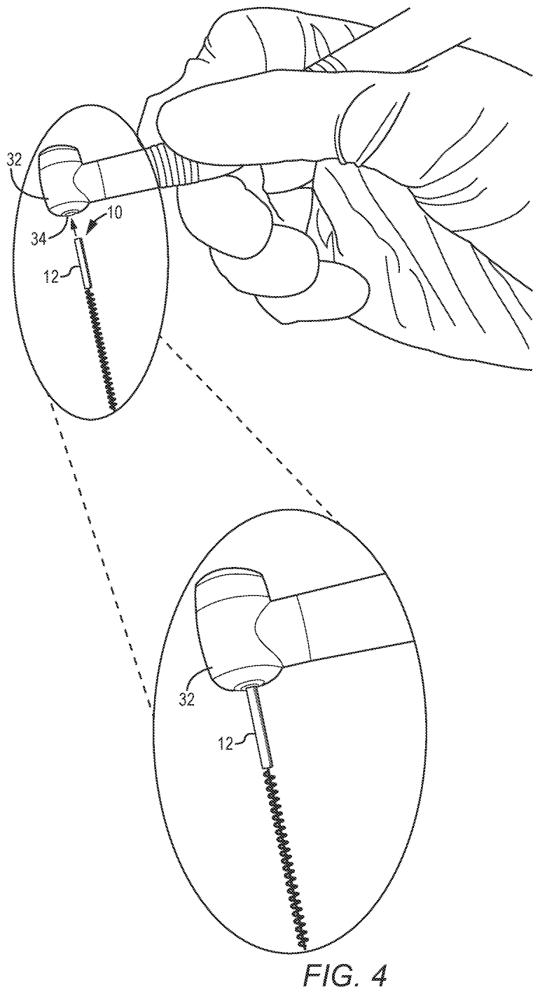

FIG. 4 illustrates the root canal filling instrument 10 in conjunction with dental hand piece 32. The dental hand piece 32 includes a chuck 34 into which the shaft 12 of the root canal filling instrument 10 is inserted and configured to fit.

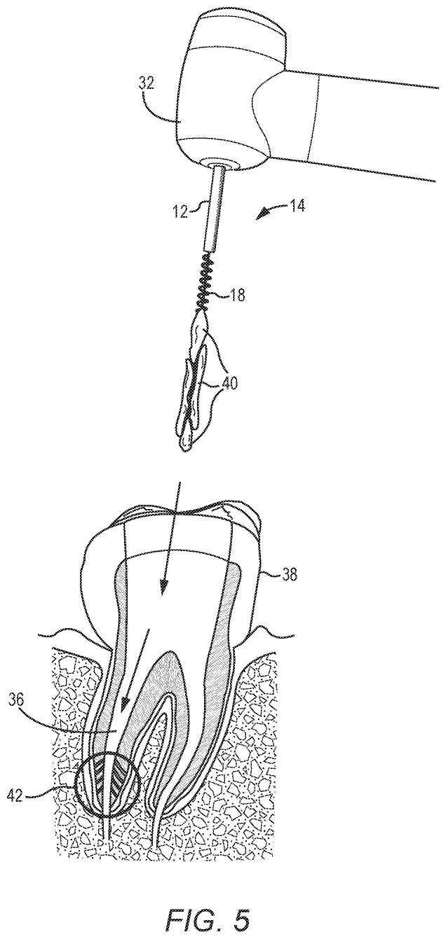

FIG. 5 illustrates the root canal filling instrument 10 immediately prior to insertion into a root canal 36 of a tooth 38. In one embodiment, material 40, such as a sealer material, may be placed on to the spiral wire 18 prior to insertion into the tooth 38. In other embodiments, the material 40 may be inserted into the root canal 36 prior to insertion of the material spreader 14 into the tooth 38. Note that the root canal 36 includes a primary channel and a plurality of lateral canals 42.

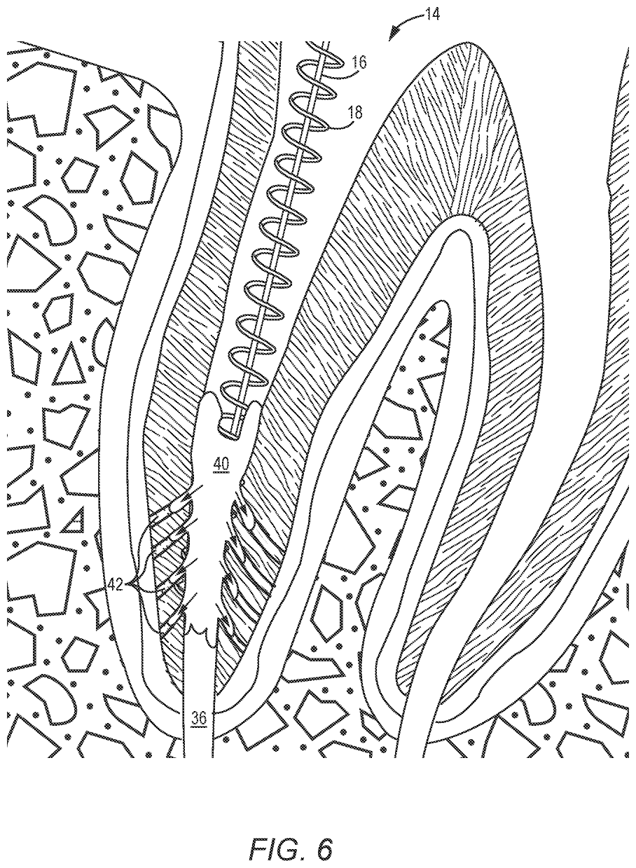

FIG. 6 illustrates the root canal filling instrument 10 urging the material 40 into the lateral canals 42, according to one embodiment. As the dental hand piece 32 (FIG. 5) rotates the material spreader 14, the spiral wire 18 also rotates, urging the material 40 into the lateral canals 42. Unlike conventional mechanisms, there is no need to apply lateral pressure to the walls of the primary channel of the root canal 36 to urge the material 40 into the lateral canals 42, which increases the chance of root fracture.

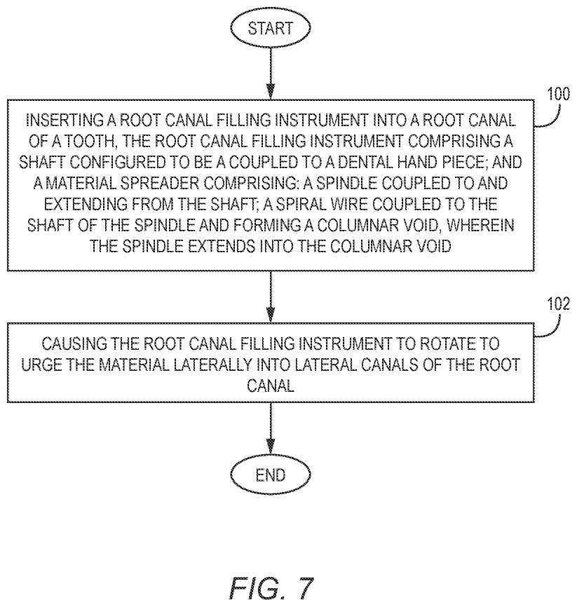

FIG. 7 is a flowchart of a method for filling a root canal of a tooth with a material according to one embodiment. The root canal filling instrument 10 is inserted into the root canal 36 of the tooth 38. The root canal filling instrument 10 includes the shaft 12, which is configured to be coupled to the dental hand piece 32, and the material spreader 14. The material spreader 14 includes the spindle 16, which is coupled to and extends from the shaft 12, and the spiral wire 18, which is coupled to the shaft 12 or to the spindle 16 and which forms a columnar void 20, wherein the spindle 16 extends into the columnar void 20 (FIG. 7, block 100). The root canal filling instrument 10 is caused to rotate to urge the material 40 laterally into the lateral canals 42 of the root canal 36 (FIG. 7, block 102).

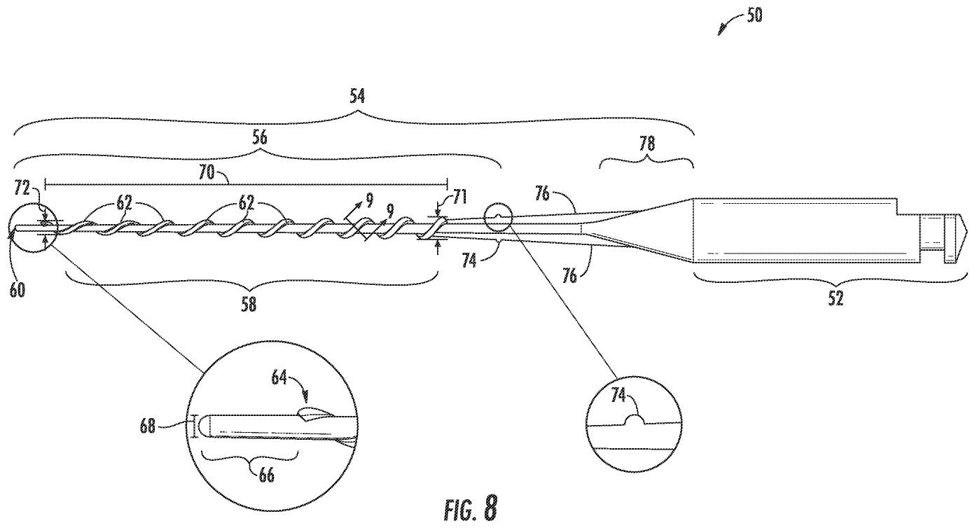

FIGS. 8-14 illustrate dental instruments according to other embodiments. Conventionally, dentists use dental instruments and techniques that remove a substantial amount of dentin from the root canal walls. Unfortunately, this weakens the tooth, and tooth fractures after root canal treatments have become common place. Accordingly, more recently, new techniques have been developed that attempt to minimize the amount of dentin removed from the root canal walls during a root canal treatment. These techniques are sometimes referred to as being “minimally invasive.” While the benefit of a minimally invasive technique retains much of the tooth's structural integrity, the minimally invasive techniques make it much more difficult for a dentist to irrigate and obturate (i.e., fill) a root canal because the space in which the dentist can work is greatly reduced. Conventional root canal instruments are not designed to obturate and irrigate minimally prepared root canals, and thus they cannot be used for minimally invasive techniques. Conventional spiral root canal instruments do not work in small canals because the spiral would have to be made so small that it would essentially become a nearly straight piece of wire which would not be effective in moving sealer within the root canal system. Even in conventional, non-minimally invasive root canal treatments, conventional spiral root canal instruments frequently break apart or unravel when the spiral root canal instrument meets resistance in the canal. If the spiral root canal instrument breaks in the root canal, a surgical procedure may be necessary to remove the broken fragment(s). While a conventional spiral root canal instrument could be made smaller, conventional materials used in such spiral root canal instruments would be even more likely to break.

FIG. 8 illustrates a perspective view of a dental instrument 50 according to one embodiment. The dental instrument 50 disperses both root canal sealers and root canal irrigants, in contrast to conventional dental instruments that disperse either root canal sealers or root canal irrigants. The dental instrument 50 includes a handle 52 and a spiral spindle 54 coupled to the handle 52. The handle 52 is configured to be coupled to the dental hand piece 32 (FIG. 4). In this embodiment, the spiral spindle 54 comprises a shaft 56 that includes a tapered shaft portion 58. In some embodiments, the tapered shaft portion 58 is symmetrical about a longitudinal axis along an entire length of the tapered shaft portion 58. In some embodiments, the spiral spindle 54 comprises a polymer, such as a liquid crystal polymer, a nylon, a polycarbonate, or the like. In some embodiments, the dental instrument 50 is a seamless integrated one-piece instrument manufactured from a polymer, via, for example a 3D printing process and/or an injection molding process.

The shaft 56 includes a rounded tip 60. The tapered shaft portion 58 may extend all the way to the rounded tip 60, or may end prior to the rounded tip 60. The spiral spindle 54 includes a rounded continuous spiral protrusion 62 that abuts the shaft 56 and is in contact with the shaft 56 such that no gap exists between the shaft 56 and the continuous spiral protrusion 62. The continuous spiral protrusion 62 has an end 64. The continuous spiral protrusion 62 ends on the shaft 56 prior to the rounded tip 60, leaving a shaft end portion 66 that protrudes beyond the end 64 of the continuous spiral protrusion 62. In some embodiments, the shaft end portion 66 has a length in a range between about 0.5 mm and about 3 mm. In some embodiments, the shaft end portion 66 has a length of about 1 mm. The continuous spiral protrusion 62 is smooth and rounded, and a perimeter of the continuous spiral protrusion 62 is defined by an arc. In some embodiments, the continuous spiral protrusion 62 also comprises a polymer.

The shaft 56 is flexible, allowing the shaft 56 to bend around corners as the shaft 56 is urged into the root canal. In some embodiments, the shaft 56 has a stiffness in a range between about 5 g-cm and 100 g-cm when measured in accordance with ADA Specification Standard No. 28.

In some embodiments, a length of the spiral spindle 54 is in a range between about 15 mm and about 50 mm. In some embodiments, the length of the spiral spindle 54 is in a range between about 21 mm and about 31 mm.

In some embodiments, a diameter 68 of the rounded tip 60 is in a range between about 0.05 mm and about 1.0 mm. In some embodiments, the diameter 68 of the rounded tip 60 is in a range between about 0.10 mm and about 0.25 mm. In some embodiments, the rounded tip 60 has a radius of about 0.16 mm.

In some embodiments, the tapered shaft portion 58 tapers at a rate in a range from about 0.01 mm to about 0.06 mm per 1 mm of length. In some embodiments, the tapered shaft portion 58 tapers at a rate about 0.02 mm per 1 mm of length. The tapered shaft portion 58, among other advantages, serves as a wedge in the root canal and forces material laterally into lateral canals.

In some embodiments, a length 70 of the continuous spiral protrusion 62 along the shaft 56 is in a range between about 5 mm to about 45 mm. In some embodiments, the length 70 of the continuous spiral protrusion 62 along the shaft 56 is in a range between about 16 mm to about 25 mm. In some embodiments, the continuous spiral protrusion 62 has a counterclockwise constant pitch. In some embodiments, the continuous spiral protrusion 62 has a largest spiral diameter 71 of about 0.85 mm and tapers to a spiral diameter 72 at the end 64 that is in a range between about 0.1 mm to about 1.0 mm. In some embodiments, the spiral diameter 72 at the end 64 is in a range between about 0.15 mm to about 0.50 mm.

The shaft end portion 66, among other advantages, greatly reduces or eliminates pushing sealer and/or irrigant into periapical tissue. The rounded tip 60, among other advantages, smoothly guides the shaft 56 down to the end of the minimally prepared root canal. The rounded continuous spiral protrusion 62 and the rounded tip 60 avoid cutting the root canal.

In some embodiments the spiral spindle 54 has an Archimedes screw design, resulting in the efficient and effective spreading of irrigants (liquids) and root canal sealers (e.g., semi-liquid pastes) throughout the root canal space both in apical and lateral directions.

The continuous spiral protrusion 62 moves liquids apically, and the spiral-less shaft end portion 66 avoids pushing sealer and irrigant out the end of the root canal.

In some embodiments the spiral spindle 54 includes a depth indicator 74, in this example in the form of two protrusions, that identifies how deep the shaft 56 is into the root canal. In some embodiments the depth indicator 74 has a height of about 0.1 mm and a radius of about 0.1 mm. In some embodiments the spiral spindle 54 includes one or more ribs 76 that provide structural rigidity to the spiral spindle 54. The spiral spindle 54 may also include a conical taper portion 78 that transitions from a diameter of the handle 52 to a diameter of the shaft 56.

FIG. 9 is a cross-section of the spiral spindle 54 along section 9-9 of FIG. 8. In this embodiment, the continuous spiral protrusion 62 has a width 79 of about 0.23 mm. In some embodiments, the continuous spiral protrusion 62 is full radius and is thus curved 180 degrees.

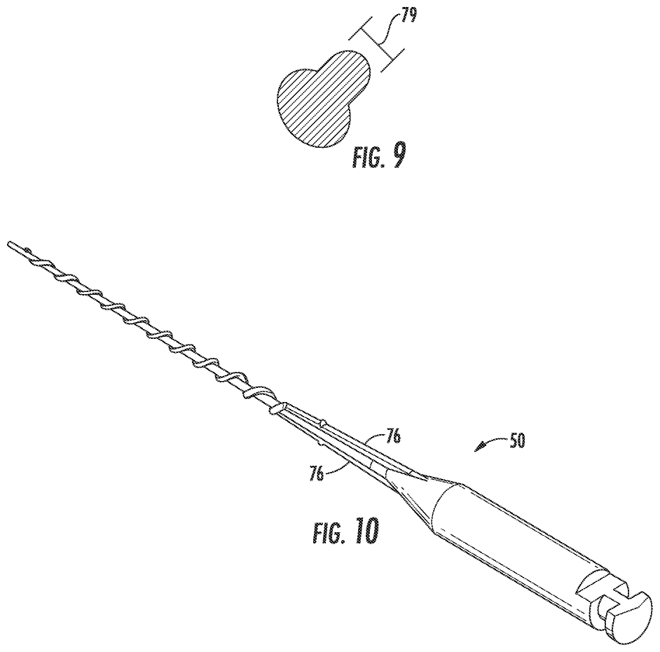

FIG. 10 illustrates another perspective view of the dental instrument 50. In some embodiments, the ribs 76 may have a width of about 0.43 mm.

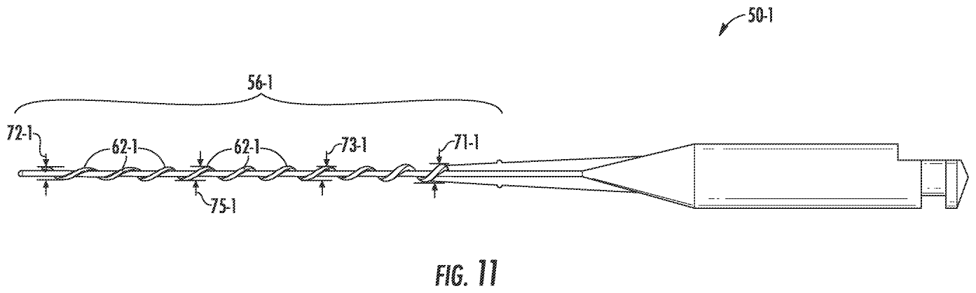

FIG. 11 illustrates a perspective view of a dental instrument 50-1 according to one embodiment. The dental instrument 50-1 is substantially the same as the dental instrument 50 and has the same material and dimensional characteristics as the dental instrument 50 except as otherwise noted herein. In this embodiment, a shaft 56-1 does not include a tapered shaft portion and has a substantially constant diameter along the length of the shaft 56-1. The shaft 56-1 includes a spiral protrusion 62-1. The height of an exterior surface of the spiral protrusion 62-1 perpendicular to a longitudinal axis of the shaft 56-1 decreases along a length of the spiral protrusion 62-1. Thus a distance 71-1 is greater than a distance 73-1, which is greater than a distance 75-1, which in turn is greater than a distance 72-1.

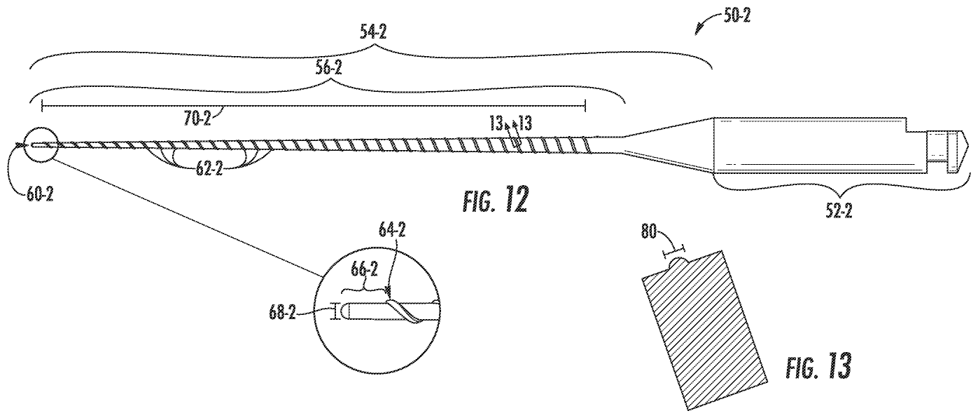

FIG. 12 illustrates a perspective view of a dental instrument 50-2 according to another embodiment. The dental instrument 50-2 is substantially similar to the dental instrument 50, except as otherwise noted or depicted herein. The dental instrument 50-2 has a handle 52-2 and a spiral spindle 54-2 coupled to the handle 52-2. The handle 52-2 is configured to be coupled to the dental hand piece 32 (FIG. 4). The spiral spindle 54-2 comprises a shaft 56-2 that may taper along the entire length of the shaft 56-2. In some embodiments, the dental instrument 50-2 is a seamless one-piece integrated instrument manufactured from a polymer, via, for example a 3D printing process and/or an injection molding process.

The shaft 56-2 includes a rounded tip 60-2. The spiral spindle 54-2 includes a rounded continuous spiral protrusion 62-2 that abuts the shaft 56-2 and is in contact with the shaft 56-2 such that no gap exists between the shaft 56-2 and the continuous spiral protrusion 62-2. The continuous spiral protrusion 62-2 has an end 64-2. The continuous spiral protrusion 62-2 ends on the shaft 56-2 prior to the rounded tip 60-2, leaving a shaft end portion 66-2 that protrudes beyond the end 64-2 of the continuous spiral protrusion 62-2. In some embodiments, the shaft end portion 66-2 has a length in a range between about 0.5 mm and about 3 mm. In some embodiments, the shaft end portion 66-2 has a length of about 1.0 mm. The continuous spiral protrusion 62-2 may also comprise a polymer.

The shaft 56-2 is flexible, allowing the shaft 56-2 to bend around corners as the shaft 56-2 is urged into the root canal. In some embodiments, the shaft 56-2 has a stiffness in a range between about 5 g-cm and 100 g-cm when measured in accordance with ADA Specification Standard No. 28.

In some embodiments, a length of the spiral spindle 54-2 is in a range between about 15 mm to about 50 mm. In some embodiments, the length of the spiral spindle 54-2 is in a range between about 21 mm and about 31 mm.

In some embodiments, a diameter 68-2 of the rounded tip 60-2 is in a range between about 0.05 mm to about 1.0 mm. In some embodiments, the diameter 68-2 of the rounded tip 60-2 is in a range between about 0.10 mm and about 0.25 mm. In some embodiments, the rounded tip 60-2 has a radius of about 0.16 mm.

In some embodiments, a length 70-2 of the continuous spiral protrusion 62-2 along the shaft 56-2 is in a range between about 5 mm to about 45 mm. In some embodiments, a length 70-2 of the continuous spiral protrusion 62-2 along the shaft 56-2 is in a range between about 16 mm to about 25 mm. In some embodiments, the continuous spiral protrusion 62-2 has a clockwise constant pitch and comprises about 40 revolutions.

FIG. 13 is a cross-section of the spiral spindle 54-2 along section 13-13 of FIG. 12. In this embodiment, the continuous spiral protrusion 62-2 has a width 80 of about 0.08 mm.

The dental instruments 50, 50-1, 50-2 preferably are sufficiently flexible to bend around short-radius curves that can be encountered within a root canal system. The dental instruments 50, 50-1, 50-2 can withstand 5000 cycles before breaking from fatigue. The dental instruments 50, 50-1, 50-2 can withstand 1 lb.-in or 112 N-mm of torque before failing under a torsional load. The dental instruments 50, 50-1, 50-2 are preferably made from a polymer that can be autoclaved up to 140° C. for 1 hour.

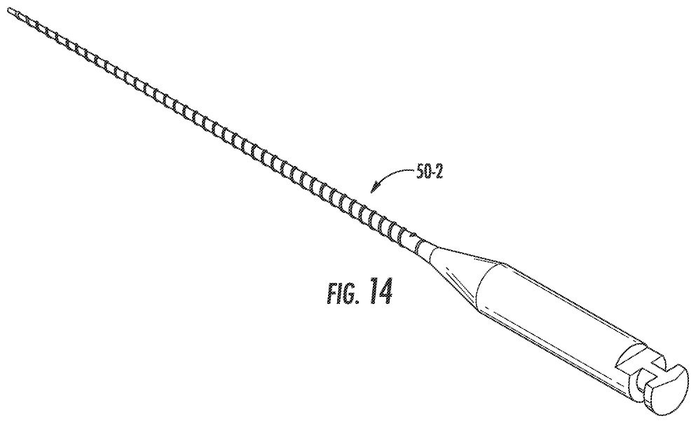

FIG. 14 illustrates another perspective view of the dental instrument 50-2 according to one embodiment.

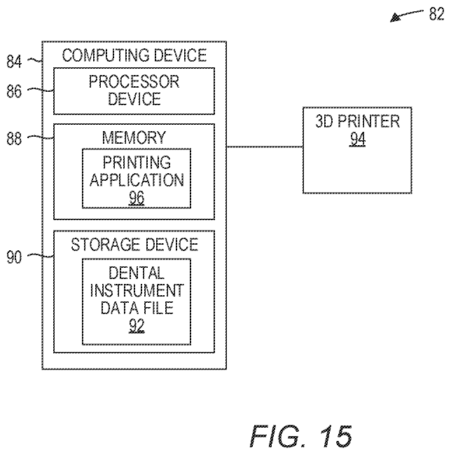

FIG. 15 is a block diagram of a system 82 suitable for manufacturing the dental instruments 50, 50-1, 50-2 according to one embodiment. The system 82 includes a computing device 84 which in turn includes a processor device 86 coupled to a memory 88. The computing device 84 includes, or is communicatively coupled to, a storage device 90. The storage device 90 includes a dental instrument data file 92 that defines the dental instrument 50, the dental instrument 50-1, or the dental instrument 50-2. For example, the dental instrument data file 92 may comprise a 3D model suitable for sending to a 3D printer 94 that is communicatively coupled to the computing device 84. A printing application 96 accesses the dental instrument data file 92, and sends the dental instrument data file 92 to the 3D printer 94. The 3D printer 94 prints the dental instrument 50, the dental instrument 50-1, or the dental instrument 50-2.

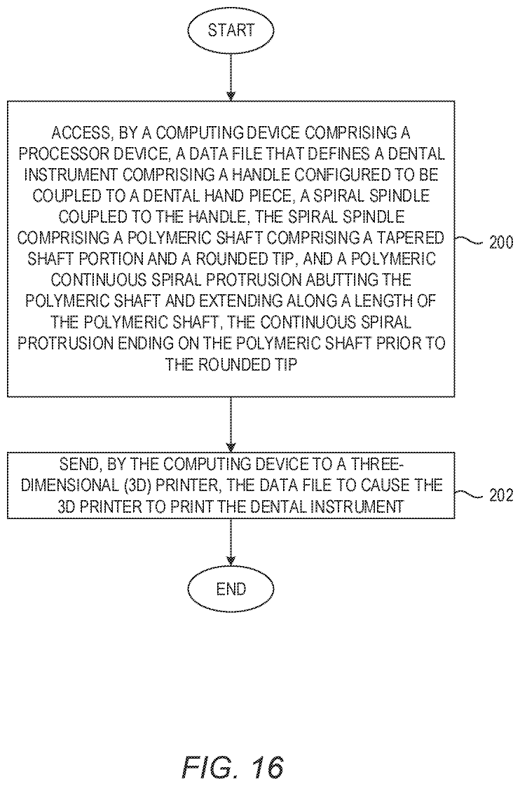

FIG. 16 is a flowchart of a method for manufacturing a dental instrument according to one embodiment. FIG. 16 will be discussed in conjunction with FIG. 15. The computing device 84 accesses the dental instrument data file 92 that defines the dental instrument that comprises a handle configured to be coupled to a dental hand piece, a spiral spindle coupled to the handle, the spiral spindle comprising a polymeric shaft comprising a tapered shaft portion and a rounded tip, and a polymeric continuous spiral protrusion abutting the polymeric shaft and extending along a length of the polymeric shaft, the polymeric continuous spiral protrusion ending on the polymeric shaft prior to the rounded tip (FIG. 16, block 200). The computing device 82 sends the dental instrument data file 92 to the 3D printer 94 to cause the 3D printer 94 to print the dental instrument 50, 50-1, or 50-2 (FIG. 16, block 202).

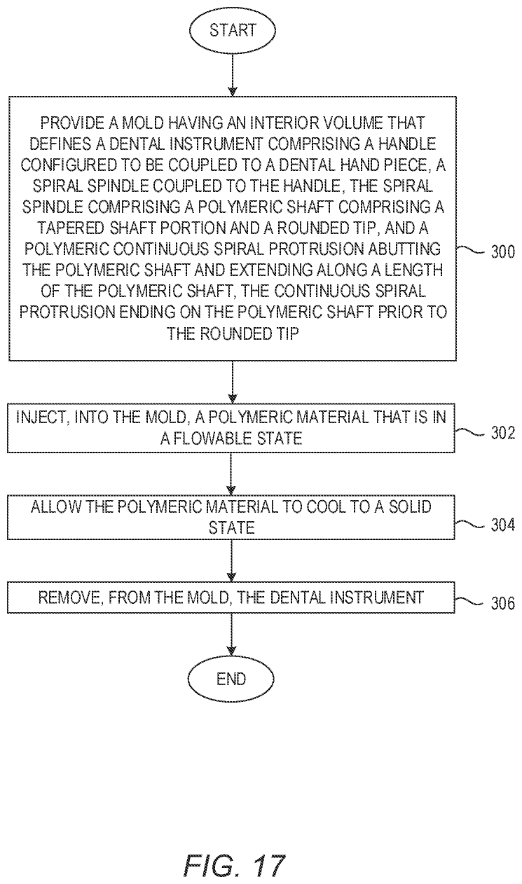

FIG. 17 is a flowchart of a method for manufacturing a dental instrument according to another embodiment. In this embodiment, a mold is provided that has an interior volume that defines a dental instrument comprising a handle configured to be coupled to a dental hand piece, a spiral spindle coupled to the handle, the spiral spindle comprising a polymeric shaft comprising a tapered shaft portion and a rounded tip, and a polymeric continuous spiral protrusion abutting the polymeric shaft and extending along a length of the polymeric shaft, the polymeric continuous spiral protrusion ending on the polymeric shaft prior to the rounded tip (FIG. 17, block 300). In some embodiments, the mold may be a clamshell mold. A polymeric material that is in a flowable state is injected into the mold (FIG. 17, block 302). The polymeric material is allowed to cool to a solid state (FIG. 16, block 304), and the dental instrument is removed from the mold (FIG. 17, block 306).

Those skilled in the art will recognize improvements and modifications to the preferred embodiments of the disclosure. All such improvements and modifications are considered within the scope of the concepts disclosed herein and the claims that follow.

1-2. (canceled)

3. A method of manufacturing comprising:
providing a mold having an interior volume that defines a dental instrument comprising:
a handle; and
a spiral spindle coupled to the handle, the spiral spindle comprising:
a shaft comprising a shaft portion and a rounded tip portion; and
a continuous spiral protrusion abutting the shaft portion and extending along a length of the shaft portion, the continuous spiral protrusion ending on the shaft portion prior to the rounded tip portion;
injecting, into the mold, a polymeric material that is in a flowable state;
allowing the polymeric material to cool to a solid state to form a polymeric dental instrument; and
removing, from the mold, the polymeric dental instrument.

4. The method of claim 3 wherein the interior volume further defines the shaft portion to be a tapered shaft portion having a consistently decreasing diameter, and further defines the rounded tip portion to have a greatest diameter no larger than a smallest diameter of the tapered shaft portion.

5. The method of claim 4 wherein the interior volume further defines the continuous spiral protrusion to have a plurality of spaced apart loops such that a portion of a surface of the tapered shaft portion is exposed between each of the spaced apart loops, the spaced apart loops including a forward surface configured to, upon rotation, urge a sealer material toward the rounded tip portion, the continuous spiral protrusion ending on the tapered shaft portion prior to the rounded tip portion.

6. The method of claim 4 wherein the interior volume further defines the tapered shaft portion to have a length between about 5.0 mm and about 50.0 mm.

7. The method of claim 4 wherein the interior volume further defines the tapered shaft portion to taper at a rate in a range from about 0.01 mm diameter to about 0.10 mm diameter per 1 mm of length.

8. The method of claim 4 wherein the interior volume further defines the tapered shaft portion to taper at a rate of about 0.02 mm diameter per 1 mm of length.

9. The method of claim 4 wherein the interior volume further defines the tapered shaft portion to have a length in a range between about 16.0 mm and about 31.0 mm.

10. The method of claim 4 wherein the interior volume further defines the tapered shaft portion to have a substantially constant diameter, and to have a height of an exterior surface of the continuous spiral protrusion perpendicular to a longitudinal axis of the shaft portion decreasing along a length of the continuous spiral protrusion.

11. The method of claim 3 wherein the interior volume further defines the shaft portion to be a cylindrical shape along a length of the shaft portion.

12. The method of claim 3 wherein the polymeric material, when cooled to a solid state, causes the dental instrument to have a stiffness in a range between about 5.0 g-cm and 100.0 g-cm when measured in accordance with ADA Specification Standard No. 28.

13. The method of claim 3 wherein the interior volume further defines a length of the rounded tip portion to be in a range between about 0.01 mm and about 3.0 mm.

14. The method of claim 3 wherein the interior volume further defines a diameter of the rounded tip portion to be in a range between about 0.10 mm and about 0.50 mm.

15. The method of claim 3 wherein the interior volume further defines the continuous spiral protrusion to have a length in a range between about 5.0 mm and about 45.0 mm.

16. The method of claim 3 wherein the interior volume further defines the continuous spiral protrusion to have a length in a range between about 16.0 mm and about 31.0 mm.

17. A method of manufacturing comprising:
accessing, by a computing device comprising a processor device, a data file that defines:
a dental instrument comprising:
a handle; and
a spiral spindle coupled to the handle, the spiral spindle comprising:
a shaft comprising a shaft portion and a rounded tip portion; and
a continuous spiral protrusion abutting the shaft portion and extending along a length of the shaft portion, the continuous spiral protrusion ending on the shaft portion prior to the rounded tip portion; and
sending, by the computing device to a three-dimensional (3D) printer, the data file to cause the 3D printer to print the dental instrument.

18. A mold having an interior volume that defines:
a dental instrument comprising:
a handle; and
a spiral spindle coupled to the handle, the spiral spindle comprising:
a shaft comprising a shaft portion and a rounded tip portion; and
a continuous spiral protrusion abutting the shaft portion and extending along a length of the shaft portion, the continuous spiral protrusion ending on the shaft portion prior to the rounded tip portion.
